(19) United States
(12) Patent Application Publication
(10) Pub. No.: US 2003/0133305 A1
(43) Pub. Date: Jul. 17, 2003

(54) Lamp with replaceable shade

(76) Inventor: Frank Chen, Taipei (TW)

Correspondence Address: FRANK CHEN, P.O. BOX 26-757, TAIPEI, 106, TW

(21) Appl. No.: 10/047,890

(22) Filed: Jan. 11, 2002

(51) Int. Cl. F21S 8/08; F21V 21/108

(52) U.S. Cl. 362/414; 362/427; 362/387

(57) ABSTRACT

A lamp with replaceable shade comprises a shade, an arm section and a bottom section. The shade contains a bulb electrically connected to a power cord and the power cord extends outward through a connector below the shade. The arm section is connected to the connector through a detachable pivotal member. A narrow receiving space is formed in a lateral side of the arm section and along a longitudinal direction. A plurality of retainers are placed in the receiving space to clamp the power cord in the receiving space along the longitudinal direction.

### FIELD OF THE INVENTION

The present invention relates to a lamp with replaceable shade, especially to a lamp with replaceable shade to provide versatile designs.

### BACKGROUND OF THE INVENTION

The lamps become of increasing importance for decoration. Diversity type of lamps such as projection lamp, ceiling lamp, hanging lamp, table lamp and desktop lamp are developed to satisfy user's need.

However, as the types of the lamps become diverse, the inventory thereof is crucial, especially when the components of the lamps such as shade and arm are not replaceable.

As shown in FIG. 1, a conventional lamp 1a comprises at least a shade 10a, an arm section 11a and a bottom section 12a. The arm section la is composed of a pair of bent racks 13 to conduct electric power to anode and cathode of a bulb (not shown) in the shade 10a. This type of design is not suitable for lamp with larger bulb wherein the bulb requires higher voltage and has safety concern. Moreover, the shade 10a and the arm section 11a are generally not replaceable because the bent racks 13 are electrically connected to the bulb in the shade 10a. Therefore, the lamps shown in this figure has the problem of inventory and design.

FIG. 2 shows another conventional lamp 2a comprising at least a shade 20a, an arm section 21a and a bottom section 22a. The bulb (not shown) in the shade 20a is powered by power cord (not shown) sealed in the arm section 21a for safety and aesthetic concern. However, in this type of lamp, the arm section 21a is generally a flexible tube and lack of replaceable ability. Therefore, the lamps shown in this figure still has the problem of inventory and design.

### SUMMARY OF THE INVENTION

It is an object of the present invention to provide a lamp with replaceable shade to provide versatile designs.

It is another object of the present invention to provide a lamp with replaceable shade, wherein the power cord thereof is movably arranged such that the projection angle of the lamp is not influenced.

To achieve above object, the present invention provides a lamp with replaceable shade, which comprises a shade, an arm section and a bottom section. The shade contains a bulb electrically connected to a power cord and the power cord extends outward through a connector below the shade. The arm section is connected to the connector through a detachable pivotal member. A narrow receiving space is formed in a lateral side of the arm section and along a longitudinal direction. A plurality of retainers are placed in the receiving space to clamp the power cord in the receiving space along the longitudinal direction.

The various objects and advantages of the present invention will be more readily understood from the following detailed description when read in conjunction with the appended drawing, in which:

### BRIEF DESCRIPTION OF DRAWING:

FIG. 1 shows a perspective view of a prior art lamp;

FIG. 2 shows a perspective view of another prior art lamp;

FIG. 3 shows a perspective view of the present invention;

FIG. 3A is an enlarged view of part A in FIG. 3;

FIG. 4 shows an exploded view of the present invention;

FIG. 5 shows a sectional view of the clamping part according to a preferred embodiment of the present invention; and

FIG. 6 shows a sectional view of the clamping part according to another preferred embodiment of the present invention.

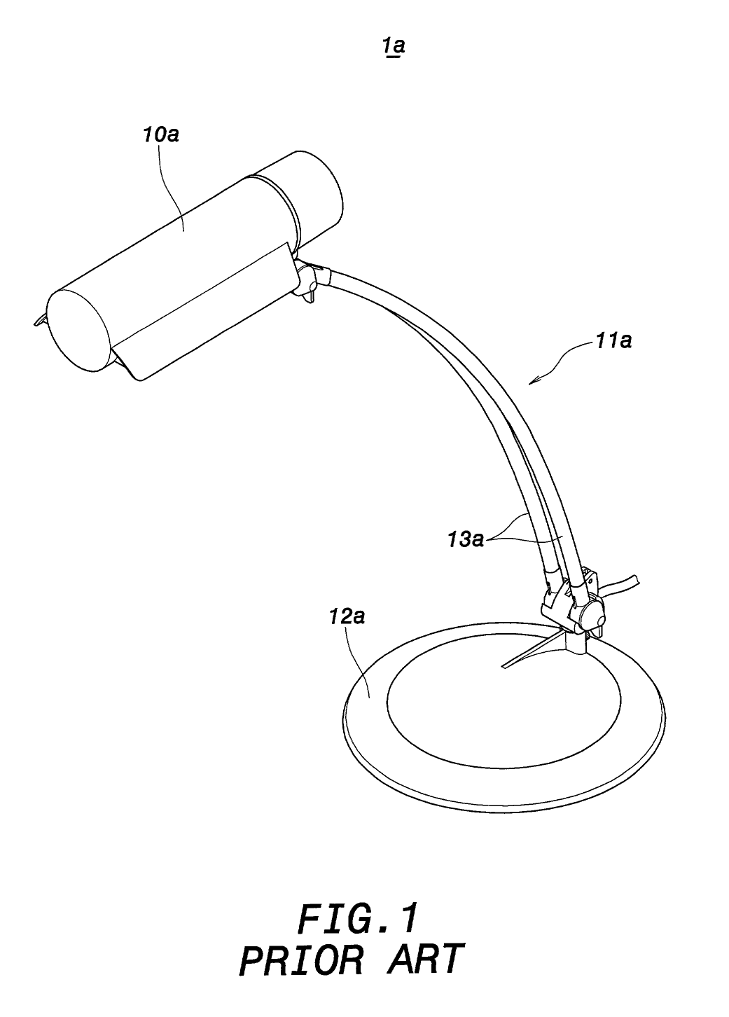

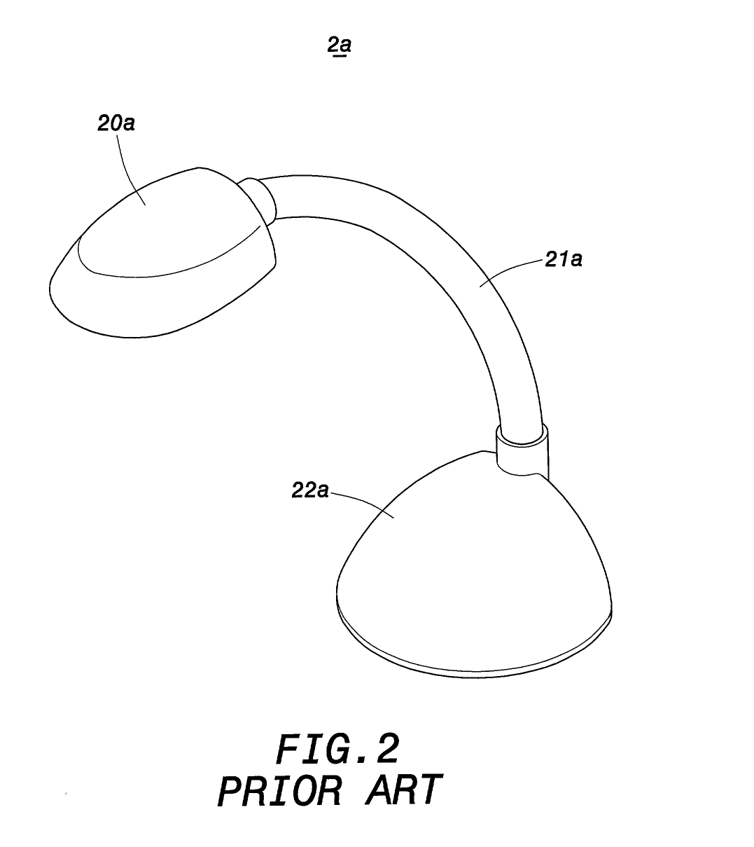

### DETAILED DESCRIPTION OF THE INVENTION

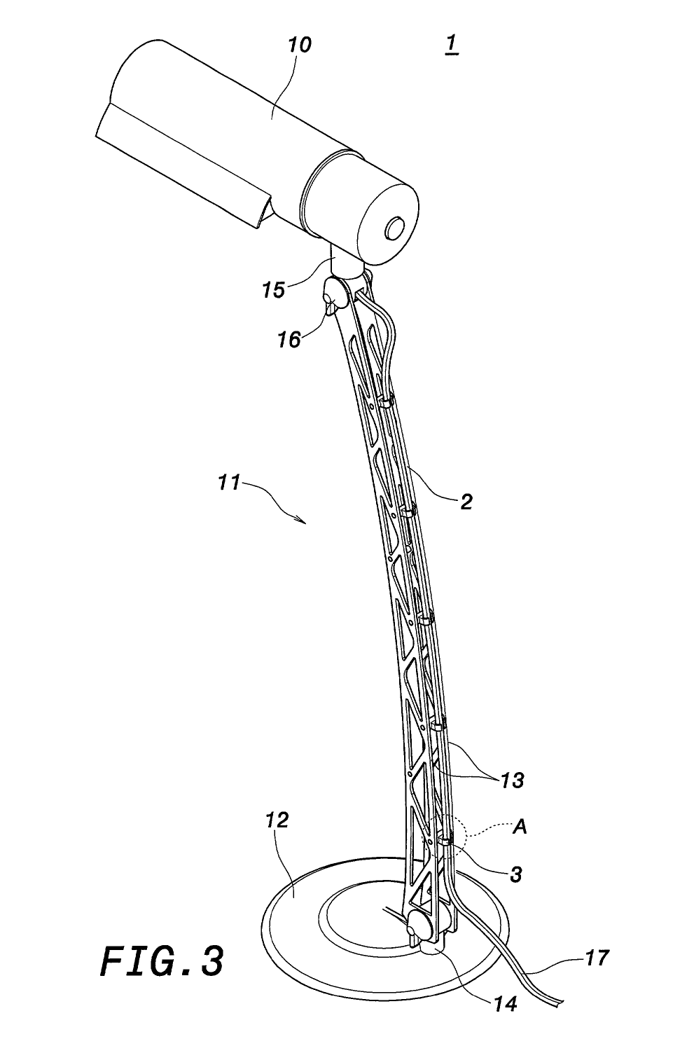

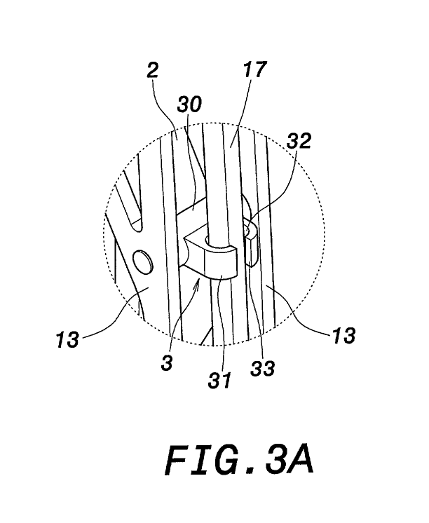

FIG. 3 shows a perspective view of the present invention and FIG. 4 shows an exploded view of the present invention, respectively. The present invention is intended to provide a lamp with replaceable shade, the lamp 1 comprising at least a shade 10, an arm section 11 and a bottom section 12. The arm section 11 is composed of two embowed panels 13 in juxtaposed arrangement. Each of the embowed panels 13 has a bottom end pivotally connected to a connection stage 14 on the bottom section 12, and a front end pivotally connected to a pivotal member 16 on a connector 15 below the shade 10, wherein the pivotal member 16 is detachable. A bulb (not shown) is arranged in the shade 10 and is powered by a power cord 17 extending out of the connector 15.

In the present invention, a narrow accommodating space 2 is formed on a lateral side of the arm section 11 along longitudinal direction. A plurality of retainers 3 is arranged within the accommodating space 2. Therefore, the power cord 17 can be retained in the accommodating space 2 along longitudinal direction. In the shown embodiment, the accommodating space 2 is formed by the two embowed panels 13 in juxtaposed arrangement and on rear side of the arm section 11. However, the accommodating space 2 can also be on front side or right/left side of the arm section 11, depending on the design of the arm section 11.

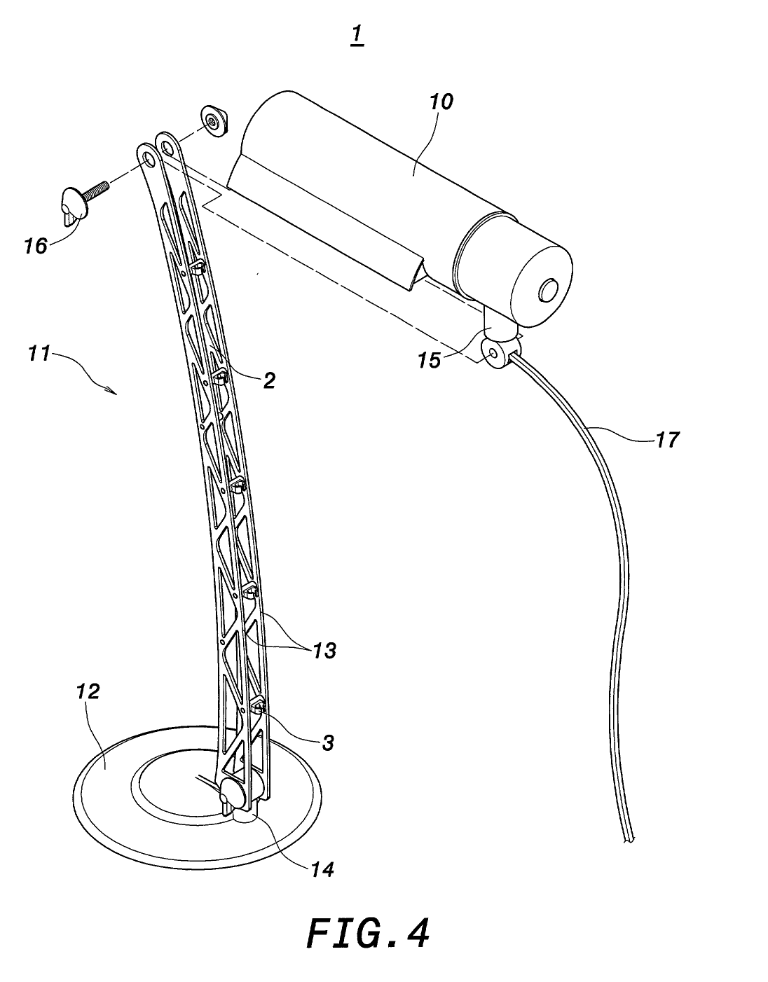

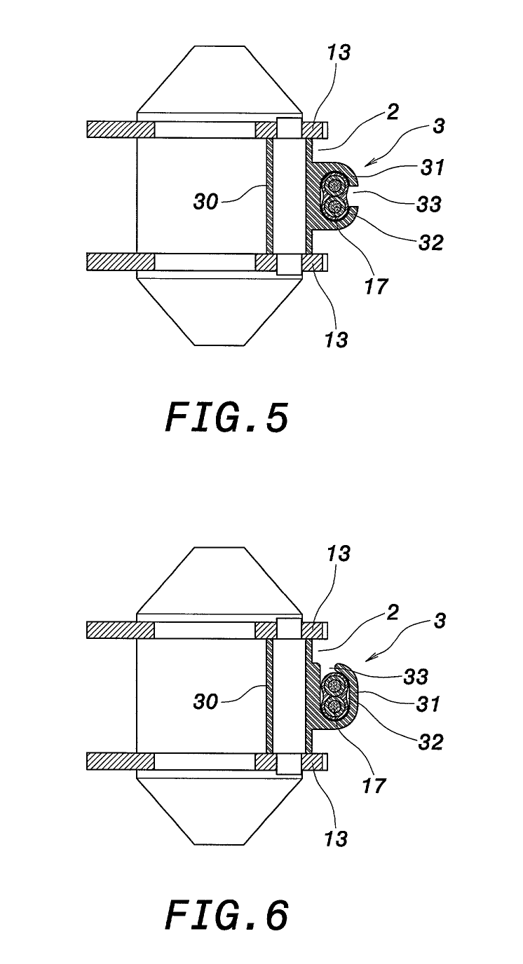

With reference also to FIG. 3A, each retainers 3 comprises a pivotal part 30 and a clamping part 31. The pivotal part 30 is of columnar shape, and transversely and pivotally arranged between the two embowed panels 13. The clamping part 31 is connected to the pivotal part 30 and has a trough hole 32 through which the power cord 17 can be movably arranged. To facilitate the arrangement of the power cord 17 into the retainers 3, the clamping part 31 has a recess 33 with width slightly smaller than that of the power cord 17. For example, the clamping part 31 has C-shaped cross section as shown in FIG. 5 or U-shaped cross section as shown in FIG. 6 to facilitate the power cord 17 to assemble into the retainers 3 through the recess 33.

Therefore, to replace the shade 10 or the arm section 11, the pivotal member 16 can be detached from the lamp and the power cord 17 is removed from the retainers 3. Afterward, components such as the shade 10, the arm section 11 or the bottom section 12 can be easily replaced.

Moreover, the power cord 17 is movably clamped in the retainers 3 along an embowed way. If the projection angle of the lamp is to be adjusted, the movable power cord 17 will not hinder the adjustment of the shade 10 and the arm section 11.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A lamp with replaceable shade, comprising
a shade containing a bulb therein, the bulb electrically connected to a power cord and the power cord extending outward through a connector below the shade;
an arm section having a front end connected to the connector through a detachable pivotal member; and
a bottom section connected to a bottom end of the arm section;
wherein a narrow receiving space is formed in a lateral side of the arm section and along a longitudinal direction, a plurality of retainers are placed in the receiving space to clamp the power cord in the receiving space along the longitudinal direction.

2. The lamp with replaceable shade as in claim 1, wherein the arm section is composed of two embowed panels, the embowed panels are in juxtaposed arrangement to form the receiving space.

3. The lamp with replaceable shade as in claim 1, wherein the receiving space is located on one of a front side, a rear side, a left side and a right side of the arm section.

4. The lamp with replaceable shade as in claim 1, wherein the retainer comprises a pivotal part and a clamping part, the pivotal part is transversely and pivotally arranged within the receiving space, and the clamping part has a trough hole through which the power cord can be movably arranged.

5. The lamp with replaceable shade as in claim 4, wherein the pivotal part is of columnar shape and has two ends connected to both sides of the receiving space.

6. The lamp with replaceable shade as in claim 4, wherein the clamping part has a recess with width slightly smaller than that of the power cord.

7. The lamp with replaceable shade as in claim 4, wherein the clamping part has one of C-shaped cross section and U-shaped cross section.
